(19) United States
(12) Patent Application Publication
(10) Pub. No.: US 2010/0299631 A1
(43) Pub. Date: Nov. 25, 2010

(54) Prompt for User Input on All Workflow Activities Before Workflow Execution

(76) Inventors: Weihsiung William Chow, Fullerton, CA (US); Boguslaw Ludwik Plewnia, Mission Viejo, CA (US); David J. Lovat, Huntington Beach, CA (US)

Correspondence Address: MICHAEL BLAINE BROOKS, PC, P.O. BOX 1630, SIMI VALLEY, CA, 93062-1630, US

(21) Appl. No.: 12/471,216

(22) Filed: May 22, 2009

(51) Int. Cl. G06F 3/048

(52) U.S. Cl. 715/806

(57) ABSTRACT

Machine-enabled methods of, and devices and systems for workflow execution based on stored user input based on prompted user inputs prior to workflow execution.

### FIELD OF ENDEAVOR

The present invention, in its several embodiments, relates to methods, devices and systems for data processing of a document including operator interface processing, and particularly pertains to workflow-type applications comprising a sequence of activities, where one or more of the activities may generate UI prompting for a user input, and the storage a user inputs prior to an activity runtime and the retrieval a user inputs at activity runtime.

### BACKGROUND

Workflow user interface (UI) generating methods are taught in US Publication No. 2009/0006997A1 by Jiang, et al. A workflow may comprise one or more workflow applications and/or one or more instances of a workflow application. A typical instance of a sequential workflow application consists of a sequence of activities at least one of which may require a user input before continuing its execution. Accordingly, one or more of the activities in a workflow may generate a UI prompting the user to provide some input. The amount of time each of the workflow activities takes to execute may be of an extended duration. Therefore, in a standard environment of workflow execution, the user may be required to be present during the entire time the workflow is executing, e.g., proximate to the UI of the computing device processing the workflow, in order to provide input via the UI, in response to a prompt UI, to some of the activities in the workflow if such a need exists. Requiring the user to be proximate at all times when a workflow having activities requiring user input is executed by a public computing device and may effectively both monopolize the user interface of the device and restrict the user from engaging in concurrent activities. For example, in some scenarios, the user needs to stand in front of a public multifunction peripheral (MFP) for the workflow activities processing until the email receiver's address is entered. So, while a first user may be waiting for a prompt to enter the receiver's email address, if another user attempts to use the same MFP to make a copy of a document, the second user must wait until the first user has been prompted to enter an intended recipient's e-mail address and does so. This prompt may be long in coming if extensive image processing is involved and such image processing activity may not be outwardly apparent to the waiting second user.

### SUMMARY

The invention, in its several embodiments, includes machine-enabled methods of, and devices and systems for workflow execution based on stored user input. For example, a method embodiment for workflow execution based on stored user input may comprise the step of: (a) determining, by a computing device, a set of activities of a workflow requiring user input; (b) prompting via a user interface for user input; (c) receiving the user input; (d) storing the user input; and (e) executing the workflow based on the stored user input. A computing device embodiment of the present invention may comprise a processing unit and addressable member where the processing unit may be configured, e.g., by loading machine executable instructions, to: (a) determine, by the computing device, a set of activities of a workflow requiring user input; (b) prompt via a user interface for user input; (c) receive the user input; (d) store the user input; and (e) execute the workflow based on the stored user input. A processor readable medium embodiment of the present invention may have, i.e., carry, a set of processor executable instructions, and these instructions, when executed in whole or in part by a processor cause the processor to: (a) determine, by a computing device comprising the processor, a set of activities of a workflow requiring user input; (b) prompt via a user interface for user input; (c) receive the user input; (d) store the user input; and (e) execute the workflow based on the stored user input.

For any of the several embodiments, the set of activities requiring user input may comprise at least one determined activity requiring a prompted user input. For any of the several embodiments: (a) the prompting may be based on one or more instructions of the user input of the at least one member of the set of determined activities requiring user input; (b) the storing of the received user input may include storing the received user input as associated with at least one member of the set of determined activities requiring user input; and/or (c) the executing of at least a portion of the workflow may comprise an activity requiring user input data being based on the stored user input associated with the activity requiring user input data.

### BRIEF DESCRIPTION OF THE DRAWINGS

Embodiments of the present invention are illustrated by way of example and not limitation in the figures of the accompanying drawings, and in which:

FIG. 1 illustrates, at a top level, an exemplary system comprising a plurality of processing devices in communication with a multi-function peripheral (MFP) device;

FIG. 2A illustrates a top level functional block diagram of an exemplary MFP device;

FIG. 2B illustrates a top level functional block diagram of an exemplary host computer that may host a driver embodiment of the present invention;

FIG. 3 illustrates a top-level functional flow diagram of an embodiment of the present invention; and

FIG. 4 illustrates a top-level functional flow diagram of another embodiment of the present invention.

### DETAILED DESCRIPTION

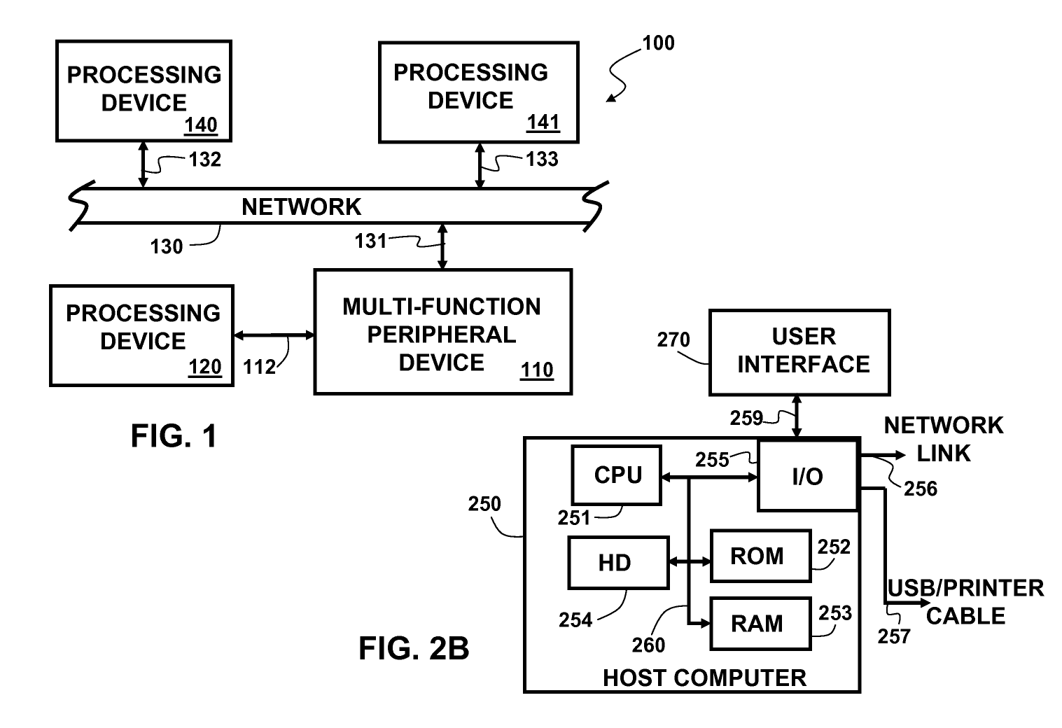

FIG. 1 illustrates an exemplary system embodiment 100 of the present invention where a printing device or a multi-functional peripheral (MFP) device 110 may be in direct communication 112 with a processing device 120, such as a computer hosting one or more drivers applicable to the printing device or multi-functional peripheral device 110. In addition, via a network 130 and a network link 131-133, the printing device or a multi-functional peripheral device 110 may be in communication with one or more processing devices 140, 141, such as a one or more computers that may each host one or more drivers applicable to the printing device or the MFP device 110.

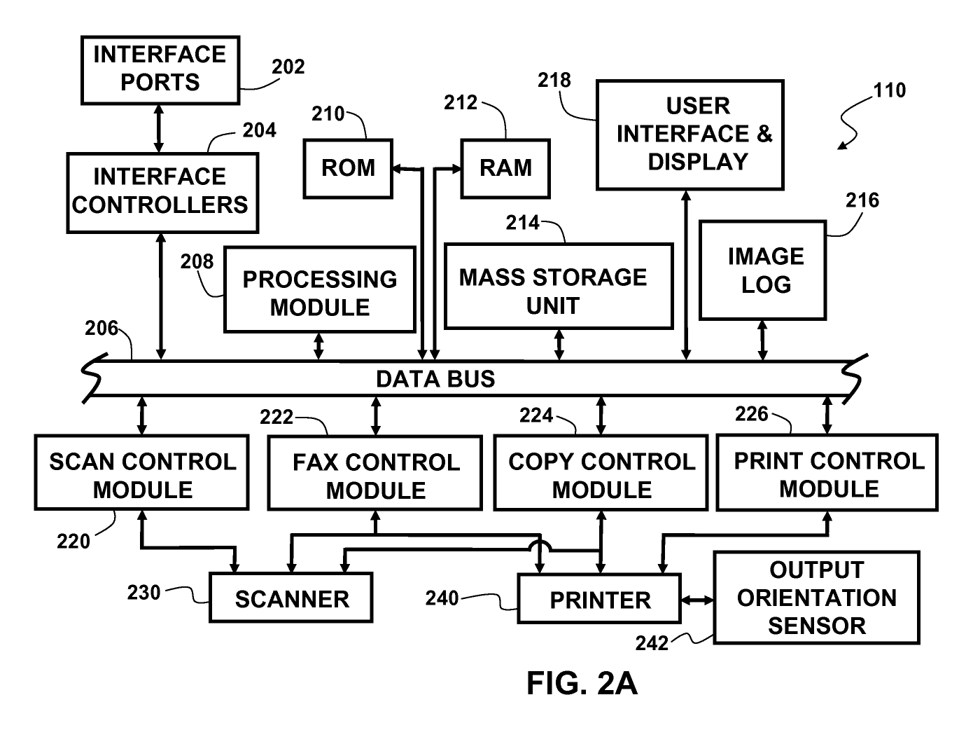

The exemplary printing device or MFP device 110 of FIG. 1 may be illustrated in greater exemplary functional detail in FIG. 2A. Interface ports 202 may be present to connect a printer cable, a network link, or an external wireless module. The interface ports 202 may be serviced by one or more interface controllers 204 that function to direct communications and/or condition signals between the respective interface port 202 and one or more modules of the MFP device 110 which may be in common communication via a data bus 206. The MFP device 110 may include one or more processing modules 208 that may draw data from read-only memory (ROM) 210 and exchange data with random access memory (RAM) 212 and may store files having sizes greater than the RAM 212 capacity in one or more mass storage units 214. The MFP device 110 may maintain a log of its images 216 and have a user display and interface 218. The image log 216 may be a separate module or distributed, for example, with a portion executed via the processing module 208 that may access parameters, files, and/or indices that may be stored in ROM 210, RAM 212, a mass storage unit 214 or in combination thereof. The MFP device 110 may include as individual or separate modules a scan control module 220, a facsimile (FAX) control module 222, and a copy control module 224 where each module may service the scanner 230 to direct communications and/or condition signals between the scanner 230 and one or more modules of the MFP device 110, for example, via the data bus 206. The MFP device 110 may include as individual or separate modules the FAX control module 222, the copy control module 224 and a print control module 226 where each module may service the printer 240 to direct communications and/or condition signals between the printer 240 and the one or more modules of the MFP device 110, for example, via the data bus 206. The exemplary MFP device 110 may store a calibration table in ROM 210, RAM 212, a mass storage unit 214 or in combination thereof and accordingly, the calibration table may be accessed by the print control module 226 and/or a processing module 208 and made available to devices external to the MFP device 110 via one or more interface ports 202. The exemplary MFP device 110 may have notice, for example, due to a user input via the user interface 218 or sensed by an output orientation sensor 242 of the printer 240 and may be communicated via the print control module 226 to devices external to the MFP device 110 via one or more interface ports 202. FIG. 2B illustrates a top level functional block diagram of a processing device that is an exemplary host computer 250 that may host a driver embodiment of the present invention that, via an input/output interface 255 may interface 259 via a user interface 270 with the exemplary MFP of FIG. 2A via a wireless or wired network link 256 or a parallel, serial, or universal serial bus (USB) cable 257. The user interface 270 may include tactile input via keyboard, mouse and/or touch screen and/or audio input via a microphone. The user interface 270 may provide output to the user via a display, e.g. a graphical user interface (GUI), and/or provide audio output to the user via one or more speakers, headphones or ear buds. The host computer 250 may further comprise a central processing unit (CPU) 251, read only memory (ROM) 252, random access memory (RAM) 253 and a mass storage unit 254, such as a hard disk drive. Two or more elements of the host computer 250 may be in communication via a data bus 260. The general accessing of data, processing of data and communication and display of data may be handled at the CPU level of the host computer 250 by an operating system such as MICROSOFT™ WINDOWS™.

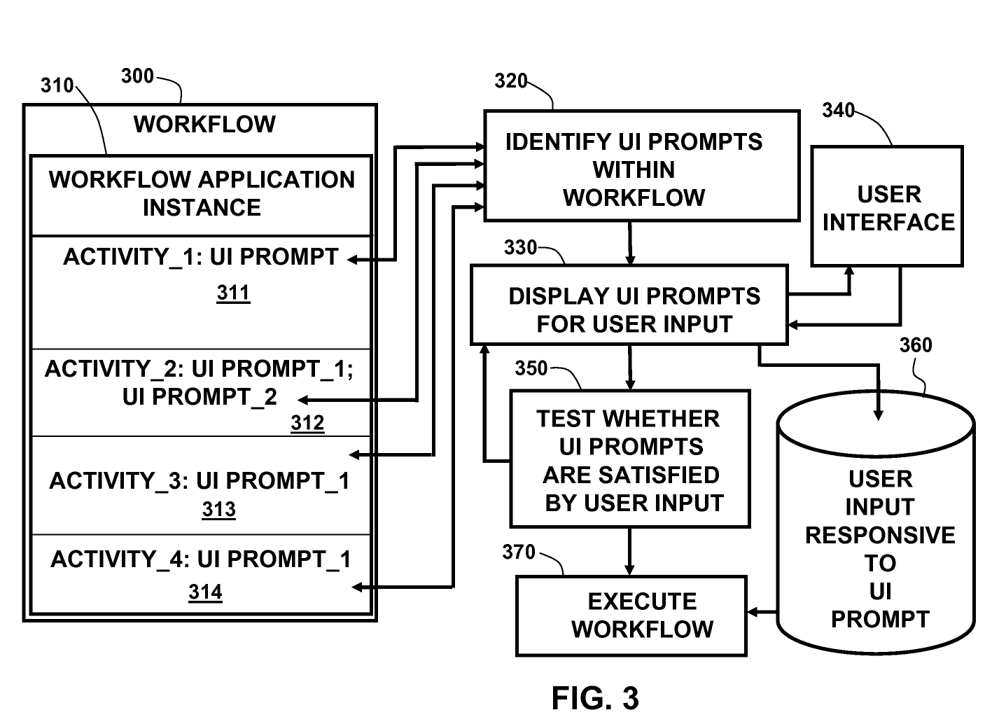

FIG. 3 illustrates an exemplary workflow 300 comprised of a workflow application instance comprising four workflow application activities 311-314 that must be executed, e.g., in a series. The workflow application instance 310, prior to its execution as instructions by one or more microprocessors, may be examined 320 for the content of its applications, particularly for the presence of user interfaces of activities, and more particularly, the presence of user interface requiring input from a user based on a prompt within the particular user interface. So, activities may be sequentially loaded and examined according to their respective sequence of occurrence in the workflow instanced. Once identified, the user interface 340 of an activity may be prompted 330 and the user input may be stored 360. The prompting and input storing may be done in series, i.e., based on the determining of a user input requirement within a particular application, or batch, i.e., once a set of determined user input requirements across all activities of the workflow instance has been established. Once the UI prompts are satisfied by user input 350, the workflow may be executed 370. Embodiments of the present invention include a device processor configured according to loaded machine readable instructions to support each activity of the workflow being executed by retrieving the stored user input when the particular activity is initiated, e.g., at runtime, and accordingly will not prompt a user for input when running. The device processor may be further configured to execute workflow instance management of the process on a per instance basis. So at any given time, there may be more than one instance of a given workflow executing and retrieving stored user inputs responsive to the process generated UI prompts. The workflow may examine each activity contained in the workflow according to the same sequence as they will be executed in. The workflow queries each activity for user interface information, such as what information is needed, what user interface to show, and what are the parameters.

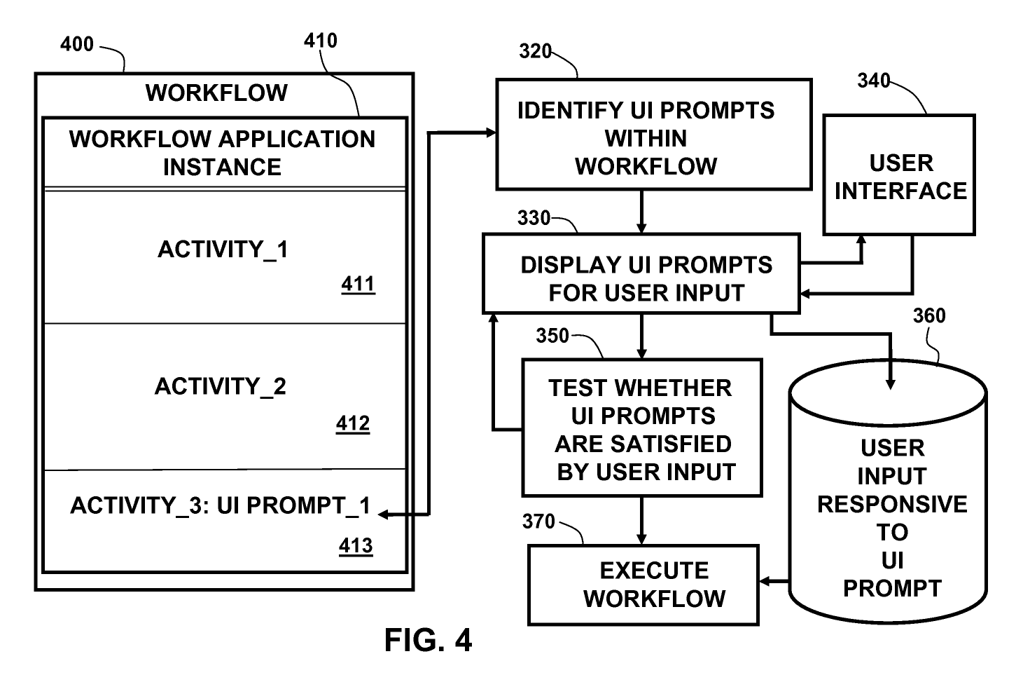

An example of running a workflow from a public MFP is illustrated in FIG. 4. In this example, workflow 400 may comprise a workflow application instance 410 comprising three activities: scan document 411, image process the scanned file 412, and send email 413 with the processed scanned document attached. The image processing activity 412, in this example, may be a computationally intensive process that requires more time than the other two activities to complete. An exemplary embodiment of the present invention examines the workflow 400 and prompts the user to enter the receiver's email address prior to the execution of the workflow application instance 410 commencing. The user need not necessarily remain proximate to the MFP waiting for the image processing activity to complete and the MFP to prompt an e-mail address input. Exemplary embodiments of the present invention allow a MFP processing of workflow to complete the workflow in the background and, at the completion of the image processing activity, the email with attachment may be sent to the desired receiver. For such exemplary embodiments, a different user or the same user use the MFP for coping or scanning. In this example, the user may be prompted to enter the email address of the intended recipient, and once it is entered, the workflow execution may start, in part by the user initiating the step to scan the document at the MFP. The post-scanning image processing phase may require a long duration, and because of the prompt-based input may be already entered by the user, the user does not need to wait for the completion of the image processing in order to be prompted to enter the intended recipient's email address. Accordingly, after the document scanning is completed, the user may leave the proximity of the MFP and let the workflow, of the MFP processing according to the present invention, run to completion by itself, i.e., without addition prompt-based inputs from the user.

One of ordinary skill in the art will also appreciate that the elements, modules, and functions described herein may be further subdivided, combined, and/or varied and yet still be in the spirit of the embodiments of the invention. In addition, while a number of variations of the invention have been shown and described in detail, other modifications, which are within the scope of this invention, will be readily apparent to those of ordinary skill in the art based upon this disclosure, e.g., the exemplary flowcharts or processes described herein may be modified and varied and yet still be in the spirit of the invention. It is also contemplated that various combinations or subcombinations of the specific features and aspects of the embodiments may be made and still fall within the scope of the invention. Accordingly, it should be understood that various features and aspects of the disclosed embodiments may be combined with or substituted for one another in order to form varying modes of the disclosed invention. Thus, it is intended that the scope of the present invention herein disclosed should not be limited by the particular disclosed embodiments described above.

### APPENDIX

The following comprises pseudocode of an exemplary embodiment of the present invention:

Presume there are multiple sequential workflows already configured in a workflow application. For example, each sequential workflow may provide different features such as scan to email; scan to then save in a folder; and similar activities. These already configured sequential workflows may be presented as items in a list for the user to select to execute. As user a selects an item from the list, an action may start as described in the following pseudo code:

```
Create a workflow instance based on the selected sequential
workflow configuration;
Current activity = undefined;
Locate the first workflow activity in the sequential workflow
(root activity) as current activity;
While current activity exists
{
    If current activity needs to prompt user input
    {
    Prompt user for input;
    Save user's input in workflow instance in a store, the stored input
    retrievable at run time;
    Mark the flag in workflow activity of workflow instance to indicate
    user input is available;
      }
    If next activity exist
        Current activity = next activity;
    Else
        Current activity = undefined;
}
Start running the workflow instance;
//workflow will be running under the control of workflow framework.
```

Note: A workflow instance may be created based on the selected workflow configuration, and the workflow instance may also include the data structure needed during the workflow execution. Once the work flow instance commences, the workflow will be executed under the control of workflow framework. The following pseudo code is an exemplary description the process steps while the workflow is running:

```
Current running activity = root activity;
While current running activity exist
{
    Execute the current running activity;
    If current running activity needs input
    {
        If user input is already available
            Retrieve user's input and continue executing;
        Else
        {
            Prompt user to input;
            Apply user's input and continue executing;
        }
    }
    Completes executing current running activity;
    Find next activity.
    Current running activity = next activity;
}
Complete the workflow;
Destroy the workflow instance;
```

What is claimed is:

1. A method workflow execution based on stored user input comprising:
determining, by a computing device, a set of activities of a workflow requiring user input;
prompting via a user interface for user input toward at least one member of the set of determined activities requiring user input;
receiving the prompted user input;
storing the received user input; and
executing at least a portion of the workflow based on the stored user input.

2. The method of workflow execution of claim 1 wherein the set of activities requiring user input comprise at least one determined activity requiring a prompted user input.

3. The method of workflow execution of claim 1 wherein the prompting is based on one or more instructions of the user input of the at least one member of the set of determined activities requiring user input.

4. The method of workflow execution of claim 1 wherein the storing of the received user input includes storing the received user input as associated with at least one member of the set of determined activities requiring user input.

5. The method of workflow execution of claim 1 wherein the executing of at least a portion of the workflow comprising an activity requiring user input data is based on the stored user input associated with the activity requiring user input data.

6. A computing device comprising:
a processing unit and addressable member; the processing unit configured to:
determine, by the computing device, a set of activities of a workflow requiring user input;
prompt via a user interface for user input;
receive the user input;
store the user input; and
execute the workflow based on the stored user input.

7. The computing device of claim 6 wherein the set of activities requiring user input comprise at least one determined activity requiring a prompted user input.

8. The computing device of claim 6 wherein the processing is further configured to prompt based on one or more instructions of the user input of the at least one member of the set of determined activities requiring user input.

9. The computing device of claim 6 wherein the processing is further configured to store the received user input as associated with at least one member of the set of determined activities requiring user input.

10. The computing device of claim 6 wherein the processing is further configured to execute at least a portion of the workflow, the workflow comprising an activity requiring user input data, based on the stored user input associated with the activity requiring user input data.

11. A processor readable medium having processor executable instructions thereon, which when executed by a processor cause the processor to:
determine, by a computing device comprising the processor, a set of activities of a workflow requiring user input;
prompt via a user interface for user input;
receive the user input;
store the user input; and
execute the workflow based on the stored user input.

12. The processor executable instructions of the processor readable medium of claim 11, when executed by a processor cause the processor to define the set of activities requiring user input as comprising at least one determined activity requiring a prompted user input.

13. The processor executable instructions of the processor readable medium of claim 11, when executed by a processor cause the processor to be further configured to prompt based on one or more instructions of the user input of the at least one member of the set of determined activities requiring user input.

14. The processor executable instructions of the processor readable medium of claim 11, when executed by a processor cause the processor to be further configured to store the received user input as associated with at least one member of the set of determined activities requiring user input.

15. The processor executable instructions of the processor readable medium of claim 11, when executed by a processor cause the processor to be further configured to execute at least a portion of the workflow, the workflow comprising an activity requiring user input data, based on the stored user input associated with the activity requiring user input data.
